(19) United States
(12) Patent Application Publication
(10) Pub. No.: US 2026/0031665 A1
(43) Pub. Date: Jan. 29, 2026

(54) STATOR, METHOD FOR MANUFACTURING THE SAME, AND VACUUM CLEANER INCLUDING THE SAME

(71) Applicant: SAMSUNG ELECTRONICS CO., LTD., Suwon-si (KR)

(72) Inventors: Soobin KWON, Suwon-si (KR); Yonghwan KIM, Suwon-si (KR); Jaeik YOON, Suwon-si (KR)

(73) Assignee: SAMSUNG ELECTRONICS CO., LTD., Suwon-si (KR)

(21) Appl. No.: 19/223,991

(22) Filed: May 30, 2025

Related U.S. Application Data
(63) Continuation of application No. PCT/KR2025/006832, filed on May 20, 2025.

(30) Foreign Application Priority Data
Jul. 23, 2024 (KR) 10-2024-0097549

(51) Int. Cl. H02K 1/14; H02K 7/14; H02K 15/026; H02K 15/0273; H02K 15/121

(52) U.S. Cl. CPC H02K 1/146; H02K 7/145; H02K 15/026; H02K 15/0273; H02K 15/121; H02K 2201/09; H02K 2213/03

(57) ABSTRACT

A vacuum cleaner may include a cleaner body, a motor in the cleaner body, the motor including: a rotor, and a stator including a stator core, the stator core including: a plurality of yokes circumferentially around the rotor, a plurality of teeth respectively corresponding to the plurality of yokes, each tooth of the plurality of teeth extending from a respectively corresponding yoke of the plurality of yokes toward the rotor, and a plurality of electrical steel sheets, each electrical steel of the plurality of electrical sheet having yoke shapes respectively corresponding to the plurality of yokes and teeth shapes respectively corresponding to the plurality of teeth, and the plurality of electrical steel sheets stacked with an adhesive layer between each two adjacent electrical steel sheets of the plurality of electrical sheets to form the stator core.

### CROSS-REFERENCE TO RELATED APPLICATIONS

This application is a continuation application of International Application No. PCT/KR2025/006832 designating the United States, filed on May 20, 2025, in the Korean Intellectual Property Receiving Office, which claims priority from Korean Patent Application No. 10-2024-0097549, filed on Jul. 23, 2024, in the Korean Intellectual Property Office, the disclosures of which are hereby incorporated by reference herein in their entireties.

### BACKGROUND

### FIELD

Various embodiments of the disclosure relate to a stator, a method for manufacturing the stator, and a vacuum cleaner including the stator.

### DESCRIPTION OF RELATED ART

Recently, stick vacuum cleaners (or cordless vacuum cleaners) without some components, such as a main body, a hose, and an electric cord, are attracting attention. A stick vacuum cleaner includes a small fan to make it lighter and/or smaller. The small fan of the stick vacuum cleaner requires a driving motor (or mini fan motor) that has a certain torque and may rotate at a high speed of 50,000 rev/min or more, or even an ultra-high speed of 100,000 rev/min or more, to generate high suction power.

The motor includes a rotor and a stator that interact electromagnetically. The rotor and/or the stator uses a core formed of a conductive metal material to form a necessary magnetic field. The cores of the stators (hereinafter, stator cores) applied to stick vacuum cleaners are smaller than the stator cores of motors applied to other home appliances and primarily adopt chain-type (or strip-type) stator cores due to differences in process caused by the smaller size.

A stator core may be manufactured by stacking a plurality of thin electrical steel sheets. Typically, an interlocking portion, which is a mechanical joining manner, is used to stack multiple electrical steel sheets. Stacking by the interlocking portion may cause a disturbance in the magnetic flux near the interlocking portion, which may break electrical insulation and increase the iron loss of the stator core.

The above-described information may be provided as related art for the purpose of helping understanding of the disclosure. No claim or determination is made as to whether any of the foregoing is applicable as background art in relation to the disclosure.

### SUMMARY

In accordance with the present disclosure, a vacuum cleaner may include: a cleaner body; and a motor in the cleaner body. The motor may include: a rotor, and a stator including a stator core. The stator core may include: a plurality of yokes circumferentially around the rotor, a plurality of teeth respectively corresponding to the plurality of yokes, each tooth of the plurality of teeth extending from a respectively corresponding yoke of the plurality of yokes toward the rotor, and a plurality of electrical steel sheets, each electrical steel sheet of the plurality of electrical steel sheets having yoke shapes respectively corresponding to the plurality of yokes and teeth shapes respectively corresponding to the plurality of teeth. The plurality of electrical steel sheets may be stacked with an adhesive layer between each two adjacent electrical steel sheets of the plurality of electrical steel sheets to form the stator core.

In accordance with the present disclosure, a stator may include a stator core. The stator core may include: a plurality of yokes circumferentially around a center of the stator core; a plurality of teeth respectively corresponding to the plurality of yokes, each tooth of the plurality of teeth extending from a respectively corresponding yoke of the plurality of yokes toward the center, and a plurality of electrical steel sheets, each electrical steel sheet of the plurality of electrical steel sheets having yoke shapes respectively corresponding to the plurality of yokes and teeth shapes respectively corresponding to the plurality of teeth. The plurality of electrical steel sheets may be stacked with an adhesive layer between each two adjacent electrical steel sheets of the plurality of electrical steel sheets to form the stator core.

In accordance with the present disclosure, a method for manufacturing a stator including a plurality of yokes, adjacent yokes of the plurality of yokes connected to each other through a bending portion, a plurality of teeth respectively corresponding to the plurality of yokes, each tooth of the plurality of teeth extending from a respectively corresponding yoke of the plurality of yokes, and a plurality of electrical steel sheets, each electrical steel sheet of the plurality of electrical steel sheets having yoke shapes respectively corresponding to the plurality of yokes and teeth shapes respectively corresponding to the plurality of teeth, the plurality of yokes may include: cutting a plurality of electrical steel sheets to form the yoke shapes and the teeth shapes in each electrical steel sheet of the plurality of electrical steel sheets; applying an adhesive layer to a surface of at least one electrical steel sheet of the plurality of electrical steel sheets that are cut; stacking the plurality of electrical steel sheets that are cut so that the adhesive layer is between each two adjacent electrical steel sheets of the plurality of electrical steel sheets to form a provisionally assembled stator; heating the provisionally assembled stator to cure the applied adhesive layer; forming an insulator by injecting an insulating material onto at least a portion of each tooth of the plurality of teeth of the provisionally assembled stator; winding a stator coil around the insulator; and bending the bending portion to form the stator into an annular shape.

The disclosure is not limited to the foregoing embodiments but various modifications or changes may rather be made thereto without departing from the spirit and scope of the disclosure.

### BRIEF DESCRIPTION OF THE DRAWINGS

FIG. 1 is a perspective view illustrating a vacuum cleaner according to an embodiment of the disclosure;

FIG. 2 is a perspective view illustrating a suction motor according to an embodiment of the disclosure;

FIG. 3 is an exploded perspective view illustrating a suction motor according to an embodiment of the disclosure;

FIG. 4 is a cross-sectional view taken along line I-I′ of FIG. 2;

FIG. 5 is a perspective view illustrating a stator core according to an embodiment of the disclosure;

FIG. 6A is a plan view illustrating the stator core of FIG. 5 before bent;

FIG. 6B is an enlarged view illustrating portion A of FIG. 6A;

FIG. 7 is a view illustrating a state in which a plurality of electrical steel sheets are stacked according to an embodiment of the disclosure;

FIG. 8 is a cross-sectional view taken along line II-II′ of FIG. 6A;

FIG. 9 is a perspective view illustrating a stator core according to an embodiment of the disclosure;

FIG. 10 is a plan view illustrating the stator core of FIG. 9 before bent;

FIG. 11 is a view illustrating a state in which a plurality of electrical iron sheets are stacked according to an embodiment of the disclosure;

FIG. 12 is a cross-sectional view taken along line III-III′ of FIG. 10;

FIG. 13 is a view illustrating an iron loss according to a fastening method of a stator core and the number of embos;

FIG. 14 is a graph illustrating a deviation in height of a stator core according to a fastening method of a stator core;

FIG. 15 is a flowchart illustrating manufacturing a stator according to an embodiment of the disclosure;

FIG. 16 is a view illustrating a stator core stacking process in a stator core manufacturing device according to an embodiment of the disclosure; and

FIG. 17 is a view illustrating a stator core stacking process in a stator core manufacturing device according to an embodiment of the disclosure.

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

It should be appreciated that various embodiments of the disclosure and the terms used therein are not intended to limit the technological features set forth herein to particular embodiments and include various changes, equivalents, or replacements for a corresponding embodiment.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

The term “and/or” may denote a combination(s) of a plurality of related components as listed or any of the components.

Hereinafter, the working principle and embodiments of the disclosure are described with reference to the accompanying drawings.

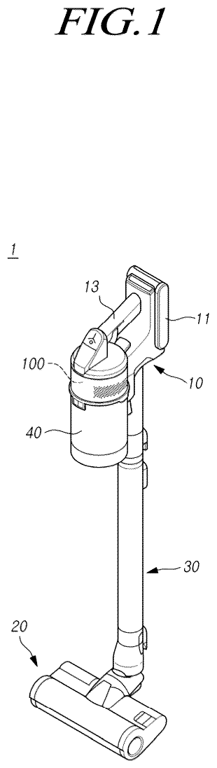

FIG. 1 is a perspective view illustrating a vacuum cleaner according to an embodiment of the disclosure.

Referring to FIG. 1, a vacuum cleaner 1 may include at least one of a cleaner body 10, a suction head 20, a stick 30, a dust collector 40, or a suction motor 100.

The suction motor 100 may be applied to various home appliances other than the vacuum cleaner 1. Hereinafter, a stick vacuum cleaner 1 including a suction motor 100 is mainly described.

According to an embodiment, a battery 11 may be accommodated in the cleaner body 10. The battery 11 may supply power to the suction motor 100.

According to an embodiment, the cleaner body 10 may be provided with a handle 13 that may be gripped by the user. The handle 13 is a portion coupled to the cleaner body 10 and may be provided to be gripped by the user to manipulate the vacuum cleaner 1. For example, a manipulation unit (not shown) may be provided on the handle 13, and the user may manipulate the vacuum cleaner 1 using the manipulation unit.

According to an embodiment, the suction head 20 may be connected to the cleaner body 10 through a stick 30. The suction head 20 may be provided at a lower portion of the cleaner body 10 and may contact the cleaned surface. The suction head 20 may introduce foreign objects such as dust or dirt on the cleaned surface into the inside (e.g., the dust collector 40) of the cleaner body 10 by the suction force generated from the suction motor 100 while in contact with the cleaned surface.

According to an embodiment, the stick 30 may have a hollow cylindrical shape. The stick 30 may serve as a passage for guiding foreign objects sucked into the suction head 20 to the cleaner body 10.

According to an embodiment, the dust collector 40 may be provided to store foreign objects such as dust or dirt on the cleaned surface sucked from the suction head 20. The dust collector 40 may be detachably coupled to the suction motor 100 to discharge the stored foreign objects to the outside.

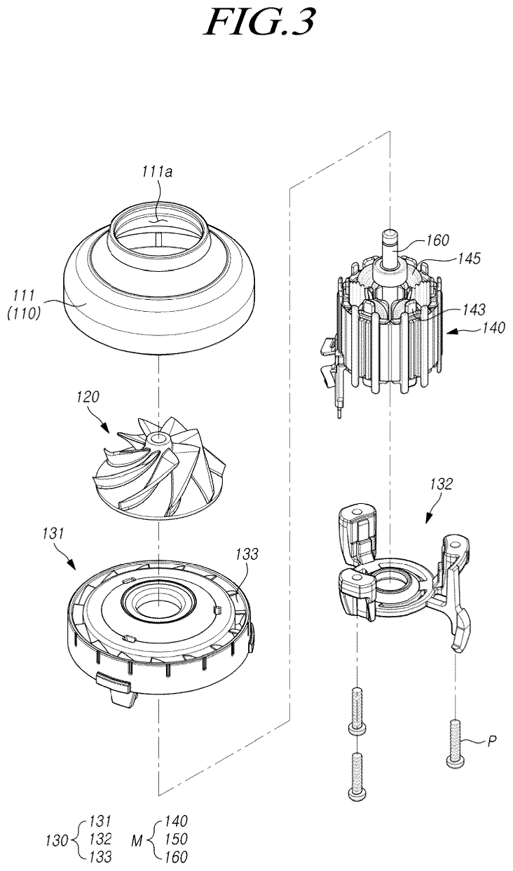

According to an embodiment, the suction motor 100 may form an air flow from the suction head 20 toward the inside of the cleaner body 10. The suction motor 100 may include a motor (e.g., the motor M of FIG. 3) for driving the vacuum cleaner 1. The motor M may generate power to generate the suction force inside the cleaner body 10.

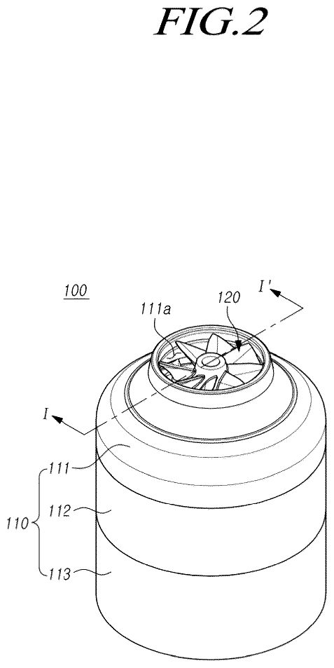

FIG. 2 is a perspective view illustrating a suction motor according to an embodiment of the disclosure.

FIG. 3 is an exploded perspective view illustrating a suction motor according to an embodiment of the disclosure.

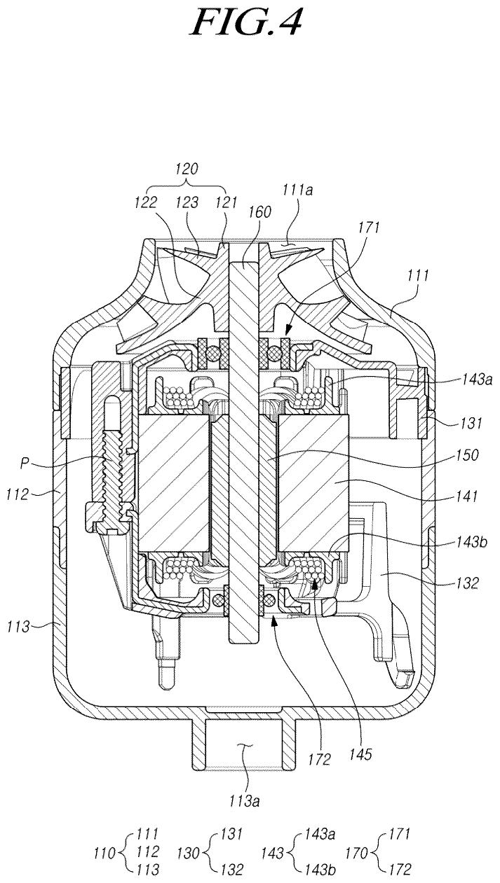

FIG. 4 is a cross-sectional view taken along line I-I′ of FIG. 2.

Referring to FIGS. 2 to 4, the suction motor 100 may include at least one of a housing 110, an impeller 120, a motor frame 130, a motor M, or a rotation shaft 160.

According to an embodiment, the housing 110 may have a detachable multi-stage structure. The housing 110 may include a first housing 111, a second housing 112 provided to be coupled with the first housing 111, and a third housing 113 provided to be coupled with the second housing 112.

According to an embodiment, the housing 110 may form an inner space in which a component such as the impeller 120, the motor frame 130, or the motor M may be disposed.

According to an embodiment, the housing 110 may have a cylindrical shape.

According to an embodiment, the first housing 111 and the second housing 112 may be provided to be detachable in the axial direction of the rotation shaft 160.

According to an embodiment, the second housing 112 and the third housing 113 may be provided to be detachable in the axial direction of the rotation shaft 160.

According to an embodiment, a suction port 111a for introducing air into the housing 110 when the motor M is driven may be provided in an upper portion of the first housing 111.

According to an embodiment, a discharge port 113a for discharging air to the outside of the housing 110 may be provided in a lower portion of the third housing 113.

According to an embodiment, the first housing 111, the second housing 112, and the third housing 113 may be coupled to each other to form an air flow path from the suction port 111a to the discharge port 113a.

According to an embodiment, the impeller 120 may include a shaft coupling portion 121, a hub 122, or a plurality of wings 123. According to an embodiment, the impeller 120 may be positioned inside the suction port 111a of the first housing 111.

According to an embodiment, the impeller 120 may be coupled to a portion of the rotation shaft 160 by the shaft coupling portion 121. The impeller 120 may rotate together with the rotor 150 by the combination of the shaft coupling portion 121 and the rotation shaft 160 and may form an air flow. The shaft coupling portion 121 may be positioned at an upper end of the hub 122.

According to an embodiment, the hub 122 may guide air introduced through the suction port 111a. The hub 122 may be provided to increase in radius away from the suction port 111a along the axial direction of the rotation shaft 160. The hub 122 may be provided to discharge air introduced along the axial direction of the rotation shaft 160 in the radial direction of the rotation shaft 160. The hub 122 may extend from the outer surface of the shaft coupling portion 121 so that the shaft coupling portion 121 is disposed at the center thereof.

According to an embodiment, the plurality of wings 123 may protrude from an outer surface (or an upper surface) of the hub 122. The plurality of wings 123 may be provided to form an air flow by rotating together with the hub 122. The plurality of wings 123 may be integrally formed with the hub 122.

According to an embodiment, the motor frame 130 may stably fix the motor M in the housing 110. According to an embodiment, the motor frame 130 may include an upper motor frame 131 and a lower motor frame 132.

According to an embodiment, the upper motor frame 131 and the lower motor frame 132 may be coupled to each other with the stator 140 and the rotor 150 interposed therebetween. For example, a stator 140 and a rotor 150 may be positioned inside the motor frames 131 and 132 coupled to each other. The upper motor frame 131 and the lower motor frame 132 may be coupled by a plurality of coupling members P. For example, the coupling member P may be a screw. The motor frame 130 (e.g., the upper motor frame 131) may be positioned under the impeller 120. The motor frame 130 (e.g., the upper motor frame 131) may be positioned so that an outer circumferential surface thereof is adjacent to an inner circumferential surface of a diffuser 133. For example, the diffuser 133 may be positioned between the second housing 112 and the motor frame 130.

According to an embodiment, the diffuser 133 may be positioned in the housing 110 (e.g., the second housing 112). The diffuser 133 may be provided in a cylindrical shape along the inner circumferential surface of the housing 110 (e.g., the second housing 112). The diffuser 133 may be formed of a plurality of ribs. The diffuser 133 may be provided to increase air pressure while guiding air discharged by the impeller 120.

According to an embodiment, the motor M may include a stator 140 and a rotor 150. The motor M may be provided in an inner space of the housing 110.

According to an embodiment, the stator 140 may include a stator core 141, an insulator 143, or a stator coil 145.

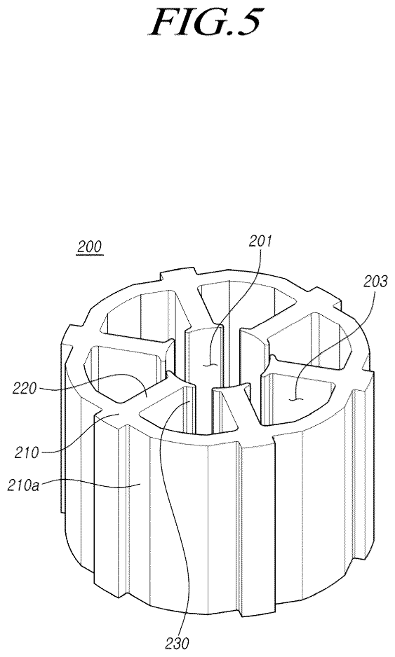

According to an embodiment, the stator 140 may be configured to generate a magnetic flux when a current is applied to the stator coil 145. The stator core 141 may have a cylindrical shape. A rotor accommodation portion (e.g., the rotor accommodation portion 201 of FIG. 5) for accommodating the rotor 150 may be provided in a central portion of the stator core 141.

According to an embodiment, the insulator 143 may be formed of a material having electrical insulation. The insulator 143 may surround at least a portion of the stator core 141 to insulate the stator core 141 from the stator coil 145. For example, the insulator 143 may include an upper insulator 143a surrounding an upper portion of the stator core 141 and a lower insulator 143b surrounding a lower portion of the stator core 141. The insulator 143 may be injection-molded.

According to an embodiment, the stator coil 145 may be wound around the stator core 141 in a state in which the insulator 143 is coupled to the stator core 141.

According to an embodiment, the rotor 150 may be provided as a permanent magnet having magnetism or may include a coil having electromagnetic properties. The rotor 150 may be inserted into the rotor accommodation portion 201 of the stator core 141. The rotor 150 may be provided to be rotatable by electromagnetically interacting with the stator 140. In an embodiment of the disclosure, it is assumed that the rotor 150 is provided as a permanent magnet.

According to an embodiment, the rotation shaft 160 may be disposed to penetrate the rotor 150. The impeller 120 may be coupled to one end portion of the rotation shaft 160 adjacent to the suction port 111a. Accordingly, the rotation shaft 160 may transfer the rotational force of the rotor 150 to the impeller 120.

According to an embodiment, a first bearing 171 and a second bearing 172 for supporting the rotation of the rotation shaft 160 may be disposed on the rotation shaft 160. For example, the first bearing 171 may be disposed to surround the outer circumferential surface of the rotation shaft 160 above the motor frame 130. For example, the second bearing 172 may be disposed to surround the outer circumferential surface of the rotation shaft 160 under the motor frames 1130.

FIG. 5 is a perspective view illustrating a stator core according to an embodiment of the disclosure.

The embodiment of FIG. 5 may be selectively combined with the embodiments of FIGS. 1 to 4 and 6a to 8.

The configuration of the stator core 200 of FIG. 5 may be identical in whole or part to the configuration of the stator core 141 of FIGS. 3 and 4.

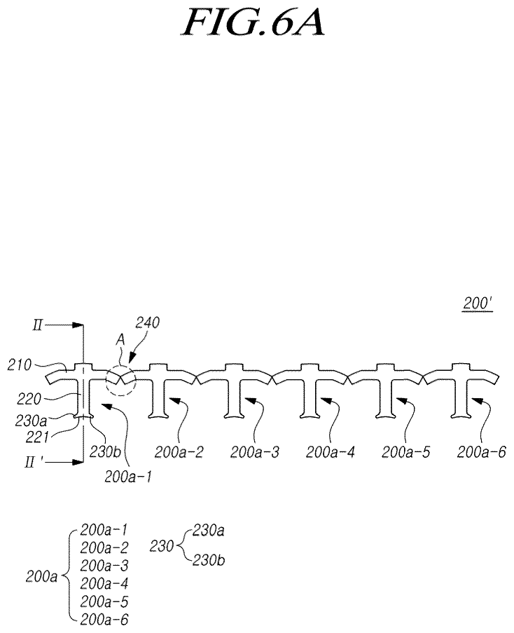

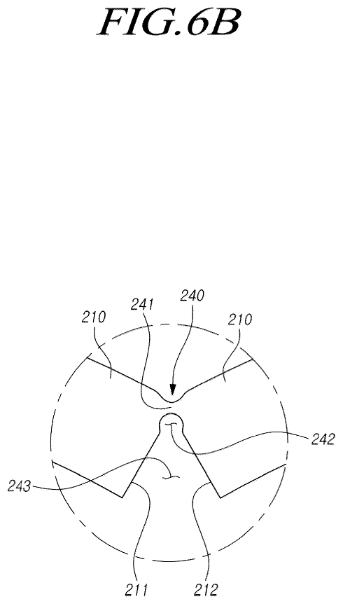

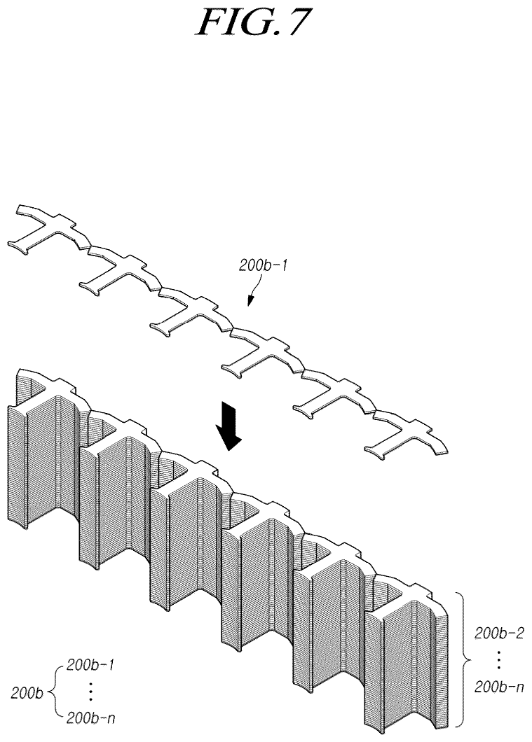

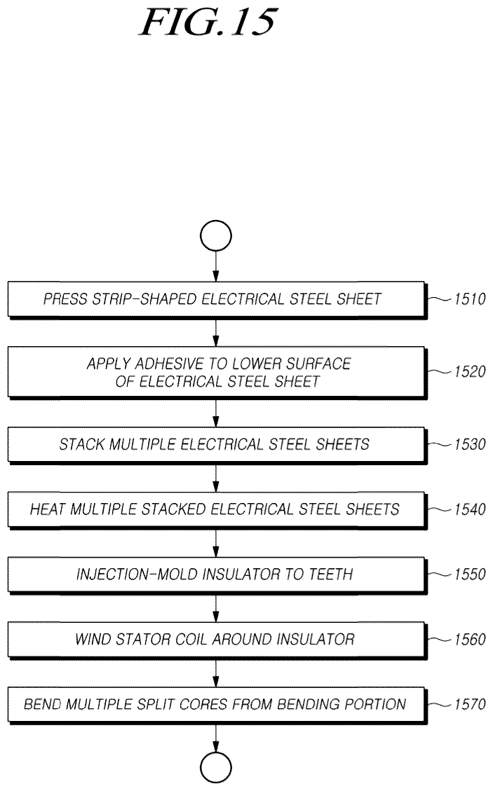

Referring to FIG. 5, the stator core 200 according to an embodiment may have a cylindrical shape. For example, the stator core 200 may be manufactured by bending a plurality of split cores 200a (see FIG. 6A) having a strip (or chain) shape by being connected to each other. The stator core 200 may be manufactured by stacking a plurality of thin electrical steel sheets (or, individual core sheets or electrical plates) (e.g., the electrical steel sheet 200b of FIG. 7). A method for manufacturing a stator core 200 is described below with reference to FIGS. 15 to 17.

According to an embodiment, the stator core 200 may be provided with a hollow rotor accommodation portion 201 into which a rotor (e.g., the rotor 150 of FIG. 3) is inserted in a central portion thereof.

According to an embodiment, the stator core 200 may include a plurality of split cores 200a. Each of the split cores 200a may include one yoke 210 and one tooth 220. For example, the stator core 200 may be composed of six split cores 200a as shown in FIG. 5. However, the disclosure is not limited thereto. Hereinafter, for convenience of description, it is assumed that the stator core 200 includes six split cores 200a.

According to an embodiment, the yoke 210 may have an arc shape. For example, the outer surface 210a of the yoke 210 may have a curved surface. The width of the yoke 210 may be designed to be, e.g., 1 mm to 3 mm. When the stator core 200 is viewed from above, the stator core 200 may have a circular shape by a plurality of yokes 210 connected to each other. The plurality of yokes 210 may define an outer diameter of the stator core 200. The outer diameter (or the outer diameter of the yoke 210) of the stator core 200 may be designed to be, e.g., 20 mm to 40 mm.

According to an embodiment, the tooth 220 may extend radially inward from the yoke 210 (e.g., in a direction toward the rotor accommodation portion 201). The width of the tooth 220 may be designed to be 0.5 mm to 3 mm, for example. The tooth 220 may be a portion of the stator core 200 around which a stator coil (e.g., the stator coil 145 of FIG. 3) is wound. The plurality of teeth 220 may be spaced apart from each other at substantially the same interval along the circumferential direction of the stator core 200. A slot 203 that is an empty space may be formed between two adjacent teeth 220 among the plurality of teeth 220. The slot 203 may be defined by an inner surface of the yoke 210 and an inner surface of two adjacent teeth 220. The stator coil 145 wound around the tooth 220 may be positioned in the slot 203.

According to an embodiment, tooth ears 230 protruding to two opposite sides may be provided at the tip (or free end) of the tooth 220. The area of the free end surface 221 of the tooth 220 may be increased as the tooth ears 230 are formed. When the stator core 200 is viewed from above, a plurality of tooth ears 230 may have a circular shape. The plurality of tooth ears 230 may define an inner diameter of the stator core 200. The inner diameter of the stator core 200 (or the inner diameter of the tooth 220) may be, e.g., 5 mm to 20 mm. The plurality of tooth ears 230 may form the rotor accommodation portion 201 radially inside.

FIG. 6A is a plan view illustrating the stator core of FIG. 5 before bent.

FIG. 6B is an enlarged view illustrating portion A of FIG. 6A.

The embodiments of FIGS. 6A and 6B may be selectively combined with the embodiments of FIGS. 1 to 5, and FIGS. 7 and 8.

The configuration of the stator core 200′ of FIGS. 6A and 6B may be identical in whole or part to the configuration of the stator core 200 of FIG. 5.

Referring to FIGS. 6A and 6B, a stator core 200′ according to an embodiment may include a plurality of split cores 200a having one yoke 210 and tooth 220.

According to an embodiment, the plurality of split cores 200a-1, 200a-2, 200a-3, 200a-4, 200a-5, and 200a-6 may be connected to each other through a bending portion 240 provided at one end of the outer surface 210a of the adjacent yoke 210. For example, the plurality of split cores 200a-1, 200a-2, 200a-3, 200a-4, 200a-5, and 200a-6 may be connected to each other in the horizontal direction. In this case, the stator core 200′ may have a strip (or chain) shape. The strip-shaped stator core 200′ may be bent inward from the bending portion 240 to be deformed into the ring-shaped stator core 200 as shown in FIG. 5.

According to an embodiment, the bending portion 240 may include a connection portion 241, a notch portion 242, or a bending space 243. The bending portion 240 may be a portion that is bent when the strip-shaped stator core 200′ is deformed into the ring-shaped stator core 200. The bending portion 240 may be provided between the yokes 210 of the adjacent split cores 200a-1, 200a-2, 200a-3, 200a-4, 200a-5, and 200a-6.

According to an embodiment, the connection portion 241 may connect the side surfaces 211 and 212 of the yokes 210 of the adjacent split cores 200a-1, 200a-2, 200a-3, 200a-4, 200a-5, and 200a-6 to each other. The connection portion 241 may be positioned radially outside the side surfaces 211 and 212 of the yokes 210. For example, the connection portion 241 may be positioned closer to the outer surface 210a of the yoke 210 than the inner surface of the yoke 210. A thickness of the connection portion 241 may be smaller than that of the yoke 210. For example, the connection portion 241 is a thin portion and may be provided to be easily bent.

According to one embodiment, the notch portion 242 may be a space formed between the yokes 210 of the adjacent split cores 200a-1, 200a-2, 200a-3, 200a-4, 200a-5, and 200a-6. The notch portion 242 may be a portion that is a cutout except for the connection portion 241 in the electric steel sheet forming the strip-shaped stator core 200′. The notch portion 242 may be open radially inward. The notch portion 242 may have a U-shape or a V-shape. The notch portion 242 may guide bending of the strip-shaped stator core 200′. For example, the strip-shaped stator core 200′ may be bent so that the side surfaces 211 and 212 of the yokes 210 of the adjacent split cores 200a-1, 200a-2, 200a-3, 200a-4, 200a-5, and 200a-6 approach each other with respect to the notch portion 242.

According to an embodiment, the bending space 243 may be formed by being recessed from the inner surface of the connection portion 241. The bending space 243 may be a space provided between the connection portion 241 and the notch portion 242. When the strip-shapedstator core 200′ is deformed into the ring-shaped stator core 200, the yokes 210 of the adjacent split cores 200a-1, 200a-2, 200a-3, 200a-4, 200a-5, and 200a-6 may contact each other, closing the portion open toward the notch portion 242.

FIG. 7 is a view illustrating a state in which a plurality of electrical steel sheets are stacked according to an embodiment of the disclosure.

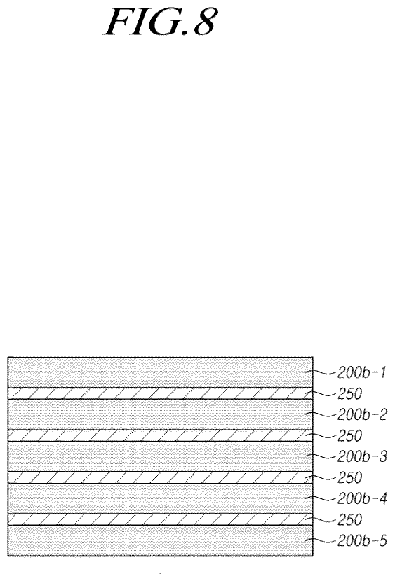

FIG. 8 is a cross-sectional view taken along line II-II′ of FIG. 6A.

The embodiments of FIGS. 7 and 8 may be selectively combined with the embodiments of FIGS. 1 to 6.

Referring to FIGS. 7 and 8, the strip-shaped stator core 200′ according to an embodiment may be manufactured as one stator core 200′ by stacking a plurality of electrical steel sheets 200b, which are thin plates.

According to an embodiment, the electrical steel sheet 200b may be pressed into shapes corresponding to a plurality of yokes 210 connected through bending portions 240 and a plurality of teeth 220 respectively extending from the yokes 210 to have a strip shape.

According to an embodiment, the plurality of electrical steel sheets 200b-1, 200b-2, . . . , 200b-n may be coupled to each other by an adhesive layer 250. For example, the plurality of electrical steel sheets 200b-1, 200b-2, 200b-3, 200b-4, and 200b-5 may be stacked in a vertical direction (e.g., an upper/lower direction). The adhesive layer 250 may be disposed between the plurality of stacked electrical steel sheets 200b-1, 200b-2, 200b-3, 200b-4, and 200b-5.

According to an embodiment, the adhesive layer 250 may be formed of a thermosetting adhesive. For example, the adhesive layer 250 may include at least one of epoxy resin, polyester resin, or acrylic resin. The stator core 200′ may be manufactured by stacking the plurality of electrical steel sheets 200b-1, 200b-2, 200b-3, 200b-4, and 200b-5 and then heating the plurality of stacked electrical steel sheets 200b-1, 200b-2, 200b-3, 200b-4, and 200b-5 to a predetermined temperature (e.g., 100° C.) or higher to cure the adhesive layer 250.

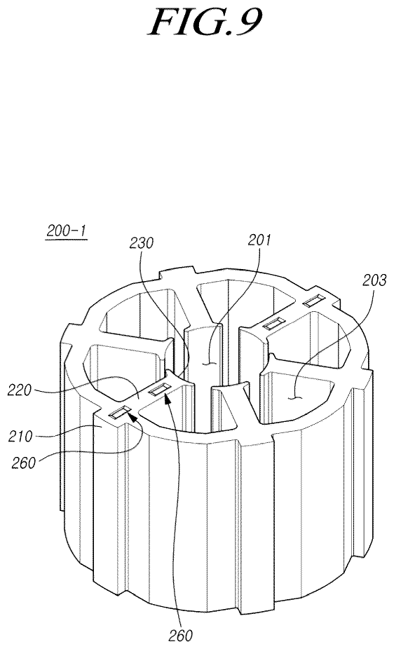

FIG. 9 is a perspective view illustrating a stator core according to an embodiment of the disclosure.

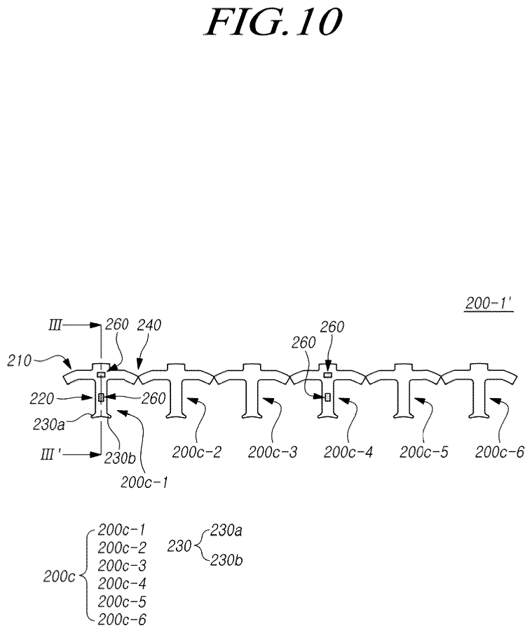

FIG. 10 is a plan view illustrating the stator core of FIG. 9 before bent.

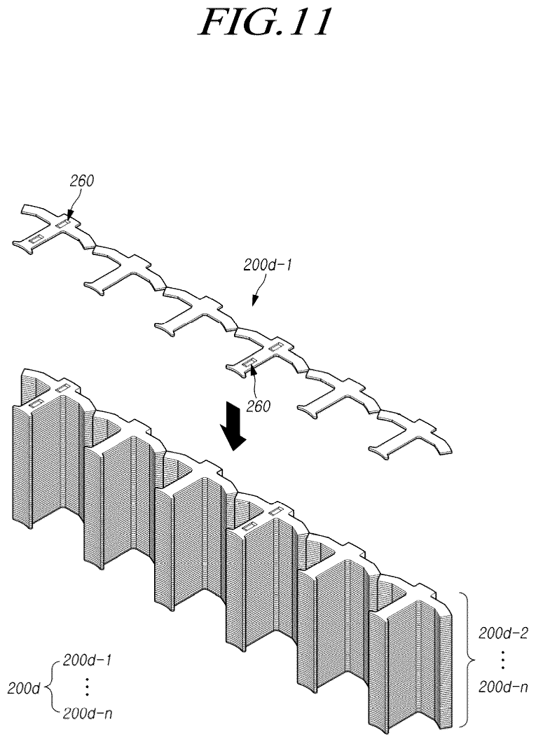

FIG. 11 is a view illustrating a state in which a plurality of electrical steel sheets are stacked according to an embodiment of the disclosure.

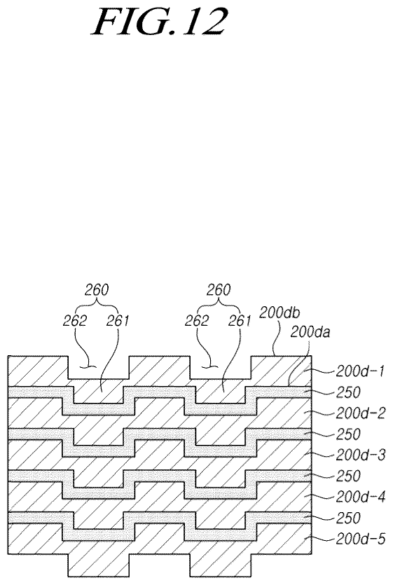

FIG. 12 is a cross-sectional view taken along line III-III′ of FIG. 10.

The embodiments of FIGS. 9 to 12 may be selectively combined with the embodiments of FIGS. 1 to 4.

The configuration of the stator core 200-1 or 200-1′ of FIGS. 9 to 12 may be identical in whole or part to the configuration of the stator core 141 of FIGS. 3 and 4.

The configuration of the stator core 200-1 or 200-1′ of FIGS. 9 to 12 may be identical in whole or part to the configuration of the stator core 200 or 200′ of FIGS. 5 to 8.

Referring to FIGS. 9 to 12, the stator core 200-1 according to an embodiment may be manufactured by bending the bending portion 240 so that the plurality of split cores 200c connected to each other to have a strip (or chain) shape form a cylindrical shape. The stator core 200-1 may be manufactured by stacking a plurality of thin-plate electrical steel sheets (or individual core sheets) 200d.

According to an embodiment, the stator core 200-1 may include a plurality of split cores 200c having one yoke 210 and one tooth 220. For example, the stator core 200-1 may be composed of six split cores 200a as shown in FIG. 9. However, the disclosure is not limited thereto. Hereinafter, for convenience of description, it is assumed that the stator core 200-1 includes six split cores 200c.

According to an embodiment, the plurality of split cores 200c-1, 200c-2, 200c-3, 200c-4, 200c-5, and 200c-6 may be connected to each other through a bending portion 240 provided at one end of the adjacent tooth 220. The stator core 200-1′ may have a strip (or chain) shape. The strip-shaped stator core 200-1′ may be bent inward from the bending portion 240 to be deformed into the ring-shaped stator core 200-1.

According to an embodiment, the strip-shaped stator core 200-1′ may be manufactured as one stator core 200-1′ by stacking a plurality of electrical steel sheets 200d-1, 200d-2, . . . , 200d-n which are thin plate.

According to an embodiment, the electrical steel sheet 200d may be pressed (or blanked) into shapes corresponding to a plurality of yokes 210 connected through bending portions 240 and a plurality of teeth 220 respectively extending from the yokes 210 to have a strip shape.

According to an embodiment, an interlocking portion 260 for stacking the plurality of electrical steel sheets 200d may be provided in the electrical steel sheet 200d. The interlocking portion 260 may be formed by pressing. The plurality of electrical steel sheets 200d may be stably stacked as the interlocking portions 260 contact each other during stacking.

According to an embodiment, the interlocking portion 260 may have an embossing structure. The interlocking portion 260 may include a protrusion 261 from a first surface 200da of the electrical steel sheet 200d, and a recess 262 from a second surface 200db of the electrical steel plate 200d opposite to the first surface 200da. For example, interlocking portion 260 may have a shape that is recessed from the upper surface of the electrical steel sheet 200d and protrudes from the lower surface. For example, the interlocking portion 260 may have a U-shaped or V-shaped vertical cross-section. The interlocking portion 260 may be referred to as an ‘embo.’

According to an embodiment, the number of the interlocking portions 260 may be smaller than the sum of the numbers of the yokes 210 and the teeth 220 included in the electrical steel sheet 200d. For example, at least two interlocking portions 260 may be provided in each electrical steel sheet 200d to prevent the stacked electrical steel sheets 200d from falling off when stacking the plurality of electrical steel sheets 200d. Specifically, as illustrated in FIG. 10, when the stator core 200-1′ is formed of six split cores 200c-1, 200c-2, 200c-3, 200c-4, 200c-5, and 200c-6, four interlocking portions 260 which are fewer than 12, which is the total sum of the numbers of the yokes 210 and the teeth 220 may be provided.

According to an embodiment, the interlocking portions 260 may be divided and disposed on the yokes 210 and the teeth 220 of the plurality of split cores 200c. For example, the interlocking portion 260 may be disposed to form a pair with the yoke 210 and the tooth 220 of one of the plurality of split cores 200c. For example, the interlocking portions 260 may be divided and disposed on the yokes 210 and the teeth 220 of different split cores 200c among the plurality of split cores 200c. For example, the interlocking portions 260 may be divided and disposed on the yokes 210 of different split cores 200c among the plurality of split cores 200c. For example, the interlocking portions 260 may be divided and disposed on the teeth 220 of different split cores 200c among the plurality of split cores 200c.

According to an embodiment, the plurality of electrical steel sheets 200d-1, 200d-2, . . . , 200d-n may be coupled to each other by an adhesive layer 250. For example, the plurality of electrical steel sheets 200d-1, 200d-2, 200d-3, 200d-4, and 200d-5 may be stacked in a vertical direction (e.g., an upper/lower direction). The adhesive layer 250 may be disposed between the plurality of stacked electrical steel sheets 200b-1, 200b-2, 200b-3, 200b-4, and 200b-5. The stator core 200-1′ may be manufactured by stacking the plurality of electrical steel sheets 200d-1, 200d-2, 200d-3, 200d-4, and 200d-5 and then heating the plurality of stacked electrical steel sheets 200d-1, 200d-2, 200d-3, 200d-4, and 200d-5 to a predetermined temperature (e.g., 100° C.) or higher to cure the adhesive layer 250.

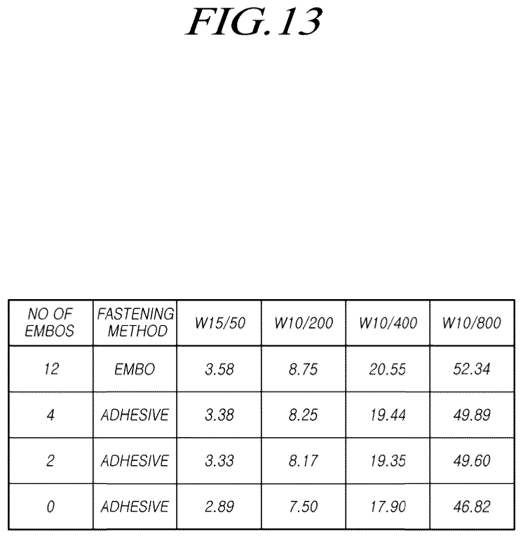

FIG. 13 is a view illustrating a change in iron loss according to a fastening method of a stator core and the number of interlocking portions.

Referring to FIG. 13, in a strip-shaped stator core formed by stacking a plurality of electrical steel sheets, the iron loss (watt loss or core loss) may be varied depending on the method of fastening (or stacking) a plurality of electrical steel sheets and the number of interlocking portions (or embos) formed in the electrical steel sheets.

For example, FIG. 13 shows the iron loss measured by varying the maximum magnetic flux density (T, Tesla) and frequency (Hz) and the fastening method for a plurality of electrical steel sheets (e.g., a fastening method using an adhesive layer 250 or a fastening method using the interlocking portions 260) when the number of split cores is six, and the total sum of the numbers of the yokes and the teeth is 12.

Although not specifically specified, when 12 interlocking portions 260 are provided in a plurality of electrical steel sheets, and the adhesive layer 250 is not used, it may be identified that the iron loss is 3.58 W at W 15/50, 8.75 W/kg at W 10/200, 20.55 W/kg at W 10/400, and 52.34 W/kg at W 10/800.

As shown in FIG. 12, when 4 interlocking portions 260 are provided in the plurality of electrical steel sheets, and the adhesive layer 250 is used as well, it may be identified that the iron loss is 3.38 W/kg at W 15/50, 8.25 W/kg at W 10/200, 19.44 W/kg at W10/400, and 49.89 W/kg at W 10/800.

Although not specifically specified, when 2 interlocking portions 260 are provided in the plurality of electrical steel sheets, and the adhesive layer 250 is used as well, it may be identified that the iron loss is 3.33 W/kg at W 15/50, 8.17 W/kg at W 10/200, 19.35 W/kg at W10/400, and 49.60 W/kg at W 10/800.

As shown in FIG. 8, when no interlocking portion 260 is provided in the plurality of electrical steel sheets, and only the adhesive layer 250 is used, it may be identified that the iron loss is 2.89 W at W 15/50, 7.50 W at W 10/200, 17.90 W at W 10/400, and 46.82 W at W 10/800.

As a result, it may be identified that as the number of interlocking portions 260 decreases, the iron loss occurring in the stator core decreases.

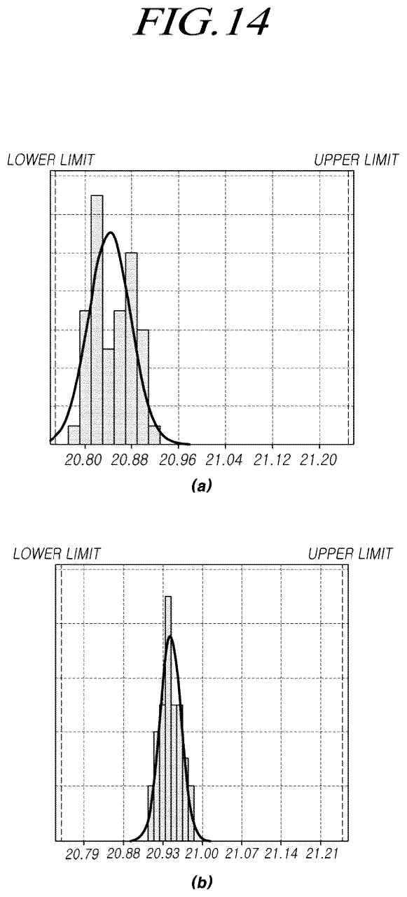

FIG. 14 is a graph illustrating a deviation in height of a stator core according to a fastening method of a stator core.

FIG. 14 shows height deviations between when a plurality of electrical steel sheets are stacked through the interlocking portions 260 ((a) of FIG. 14) and when a plurality of electrical steel sheets are stacked through the adhesive layer 250 ((b) of FIG. 14) in a stator core having a lower limit to 20.75 mm and an upper limit to 21.25 mm in the height specifications.

Referring to FIG. 14(a), when the plurality of electrical steel sheets are stacked through the interlocking portions 260 without using the adhesive layer 250, it may be identified that the average height of the stator core is 20.84 mm, and the standard deviation is 0.036.

Referring to FIG. 14(b), when the plurality of electrical steel sheets are stacked through the adhesive layer 250 without using the interlocking portions 260, it may be identified that the average height of the stator core is 20.94 mm, and the standard deviation is 0.018.

Resultantly, it may be identified that using the adhesive layer 250 exhibits a smaller height deviation than using the interlocking portions 260 among the methods for fastening the plurality of electrical steel sheets.

FIG. 15 is a flowchart illustrating manufacturing a stator according to an embodiment of the disclosure.

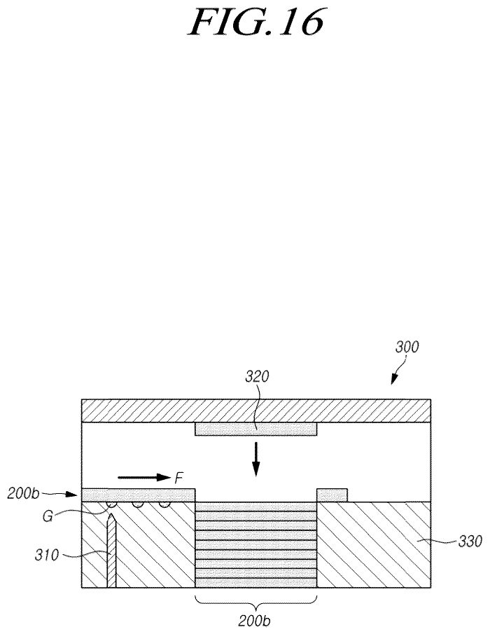

FIG. 16 is a view illustrating a stator core stacking process in a stator core manufacturing device according to an embodiment of the disclosure.

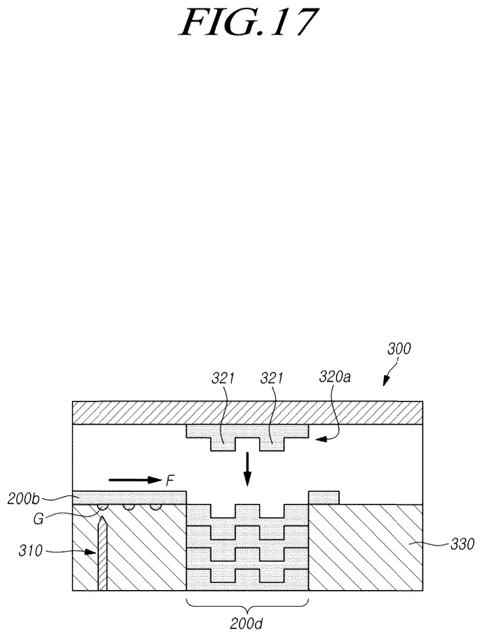

FIG. 17 is a view illustrating a stator core stacking process in a stator core manufacturing device according to an embodiment of the disclosure.

Referring to FIGS. 15 to 17, a method for manufacturing a stator core 200 or 200-1 according to an embodiment may include a process 1510 of pressing (or blanking) a strip-shaped electrical steel sheet 200b in which shapes corresponding to the split cores 200a are connected to each other. For example, the electrical steel sheet 200b unwound from the coil (not shown) and transported along the arrow direction F may be punched by a molding device (not shown) disposed in the manufacturing device 300 into shapes corresponding to the yokes 210 and the teeth 220 of the stator core 200 or 200-1.

According to an embodiment, the method for manufacturing the stator core 200 or 200-1 may include a process 1520 of applying the adhesive G to the lower surface of the pressed electrical steel sheet 200b. For example, the adhesive G may be applied to the lower surface of the electrical steel sheet 200b in a dot pattern through an injector 310.

According to an embodiment, the method for manufacturing the stator core 200 or 200-1 may include a process 1530 of sequentially stacking a plurality of electrical steel sheets 200b to which the adhesive G is applied. For example, when the plurality of electrical steel sheets 200b are stacked using only the adhesive G, as shown in FIG. 16, a block-shaped male mold 320 descends toward a female mold 330 on which the electrical steel sheets 200b are placed, contacting and pressing the electrical steel sheets 200b to stack the plurality of electrical steel sheets 200b. For example, when the adhesive G and the interlocking portions 260 are used together, as shown in FIG. 17, a male mold 320a having protrusions 321 descends toward a female mold 330 on which the electrical steel sheets 200b are placed, contacting and pressing the electrical steel sheets 200b to stack the plurality of electrical steel sheets 200b. In this case, as the electrical steel sheet 200b is pressed by the protrusions 321 of the male mold 320a, the interlocking portions 260 may be formed in the electrical steel sheet 200d.

According to an embodiment, the method for manufacturing the stator core 200 or 200-1 may include a heating process 1540 of heating the plurality of electrical steel sheets 200b and 200d. For example, the plurality of stacked electrical steel sheets 200b and 200d may be heated simultaneously with process 1530 through a heater provided in the male and female molds 320, 320a and 330, thereby curing the applied adhesive G. For example, the plurality of stacked electrical steel sheets 200b and 200d may be heated after process 1530 through a heater provided outside the male and female molds 320, 320a and 330, thereby curing the applied adhesive G.

According to an embodiment, the method for manufacturing the stator core 200 or 200-1 may include a process 1550 of injection-molding an insulator 143 surrounding the teeth 220 of the strip-shaped stator core 200′ or 200-1′.

According to an embodiment, the method for manufacturing the stator core 200 or 200-1 may include a process 1560 of winding a stator coil 145 around the injection-molded insulator 143 and/or teeth 220.

According to an embodiment, the method for manufacturing the stator core 200 or 200-1 may include a process 1570 of bending and/or welding the strip-shaped stator core 200′ or 200-1′ around which the stator coil 145 is wound, based on the bending portion 240. For example, the strip-shaped stator core 200-1′ may be bent inward from the bending portion 240 to be deformed into the ring-shaped stator core 200 or 200-1. Thereafter, the annular stator core 200 or 200-1 may be integrated by welding the joint of the bending portion 240.

A vacuum cleaner 1 according to an embodiment of the disclosure may comprise a cleaner body 10, and a motor M in the cleaner body 10. The motor M may include a rotor 150 and, a stator 140 including a stator core 200, 200-1. The stator core 200, 200-1 may include a plurality of yokes 210 circumferentially around the rotor 150, a plurality of teeth 220 respectively corresponding to the plurality of yokes 210, each tooth of the plurality of teeth 220 extending from the plurality of yokes 210 toward the rotor 150, and a plurality of electrical steel sheets 200b, 200d, each electrical steel sheet 200b, 200d of the plurality of electrical steel sheets 200b, 200d having yoke shapes respectively corresponding to the plurality of yokes 210 and teeth shapes respectively corresponding to the plurality of teeth 220. The plurality of electrical steel sheets 200b, 200d may be stacked with an adhesive layer 250 between each two adjacent electrical steel sheets 200b, 200d of the plurality of electrical steel sheets 200b, 200d to form the stator core 200, 200-1.

According to an embodiment, each electrical steel sheet 200d of the plurality of electrical steel sheets 200d may include an interlocking portion 260 having an embossed structure so that, in the stack of the plurality of electrical steel sheets 200d, interlocking portions 260 of adjacent electrical steel sheets 200d of the plurality of electrical steel sheets 200d interlock.

According to an embodiment, the interlocking portion 260 may include: a protrusion 261 from a first surface 200da, and a recess 262 from a second surface 200db opposite the first surface 200da. The protrusion 261 may protrude into the recess 262 of an adjacent electrical steel sheet 200d of the plurality of electrical steel sheets 200d in the stack of the plurality of electrical steel sheets 200d.

According to an embodiment, the interlocking portion 260 may be on at least one yoke shape or at least one tooth shape.

According to an embodiment, for each electrical steel sheet 200d of the plurality of electrical steel sheets 200d, a number of interlocking portions 260 may be less than a sum of a number of the yoke shapes and a number of the teeth shapes.

According to an embodiment, the interlocking portion 260 may include two or more interlocking portions 260.

According to an embodiment, the stator core 200, 200-1 may include a bending portion 240 that connects adjacent yokes of the plurality of yokes 210. The bending portion 240 may be bent toward a center of the stator core 200, 200-1 so that the stator core 200, 200-1 has an annular shape.

According to an embodiment, the adhesive layer 250 may include thermosetting adhesive.

According to an embodiment, each yoke of the plurality of yokes 210 may have a width of 1 mm to 3 mm. Each tooth of the plurality of teeth 220 may have a width of 0.5 mm to 3 mm.

According to an embodiment, the stator core 200, 200-1 may have an annular shape. Each yoke of the plurality of yokes 210 may have an outer diameter of 20 mm to 40 mm.

According to an embodiment, the stator core 200, 200-1 may have an annular shape. Each tooth of the plurality of teeth 220 may have an inner diameter of 5 mm to 20 mm.

A stator 140 according to an embodiment of the disclosure may include a stator core 200, 200-1. The stator core 200, 200-1 may include a plurality of yokes 210 circumferentially around a center of the stator core 200, 200-1, a plurality of teeth 220 respectively corresponding to the plurality of yokes 210, each tooth of the plurality of teeth 220 extending from a respectively corresponding yoke of the plurality of yokes 210 toward the center, and a plurality of electrical steel sheets 200b, 200d, each electrical steel sheet 200b, 200d of the plurality of electrical steel sheets 200b, 200d having yoke shapes respectively corresponding to the plurality of yokes 210 and teeth shapes respectively corresponding the plurality of teeth 220. The plurality of electrical steel sheets 200b, 200d may be stacked with an adhesive layer 250 between each two adjacent electrical steel sheets 200b, 200d of the plurality of electrical steel sheets 200b, 200d to form the stator core 200, 200-1.

A method for manufacturing a stator 140 including a plurality of yokes 210, adjacent yokes of the plurality of yokes 210 connected to each other through a bending portion 240, a plurality of teeth 220 respectively corresponding to the plurality of yokes 210, each tooth of the plurality of teeth 220 extending from a respectively corresponding yoke of the plurality of yokes 210, and a plurality of electrical steel sheets 200b, 200d, each electrical steel sheet 200b, 200d of the plurality of electrical steel sheets 200b, 200d having yoke shapes respectively corresponding to the plurality of yokes 210 and teeth shapes respectively corresponding to the plurality of teeth 220, according to an embodiment of the disclosure, may comprise cutting a plurality of electrical steel sheets 200b, 200d to form the yoke shapes and the teeth shapes in each electrical steel sheet 200b, 200d of the plurality of electrical steel sheets 200b, 200d; applying an adhesive layer 250 to a surface of at least one electrical steel sheet 200b, 200d of the plurality of electrical steel sheets 200b, 200d that are cut; stacking the plurality of electrical steel sheets 200b, 200d that are cut so that the adhesive layer 250 is between each two adjacent electrical steel sheets 200b, 200d of the plurality of electrical steel sheets 200b, 200d to form a provisionally assembled stator 200′, 200-1′; heating the provisionally assembled stator to cure the applied adhesive layer 250; forming an insulator 143 by injecting an insulating material onto at least a portion of each tooth of the plurality of teeth 220 of the provisionally assembled stator 200′, 200-1′; winding a stator coil 145 around the insulator 143; and bending the bending portion 240 to form the stator 200, 200-1 into an annular shape.

According to an embodiment, the method for manufacturing the stator 140 may further comprise embossing an interlocking portion 260 into each electrical steel sheet 200b of the plurality of electrical steel sheets 200b so that interlocking portions 260 of adjacent electrical steel sheets 200b of the plurality of electrical steel sheets 200b interlock when stacked.

According to an embodiment, the heating may be performed simultaneously with the stacking or after the stacking is completed.

What is claimed is:

1. A vacuum cleaner, comprising:
a cleaner body;
a motor in the cleaner body, the motor including:
a rotor, and
a stator including a stator core, the stator core including:
a plurality of yokes circumferentially around the rotor,
a plurality of teeth respectively corresponding to the plurality of yokes, each tooth of the plurality of teeth extending from a respectively corresponding yoke of the plurality of yokes toward the rotor, and
a plurality of electrical steel sheets, each electrical steel sheet of the plurality of electrical steel sheets having yoke shapes respectively corresponding to the plurality of yokes and teeth shapes respectively corresponding to the plurality of teeth, and
wherein the plurality of electrical steel sheets are stacked with an adhesive layer between each two adjacent electrical steel sheets of the plurality of electrical steel sheets to form the stator core.

2. The vacuum cleaner of claim 1, wherein each electrical steel sheet of the plurality of electrical steel sheets includes an interlocking portion having an embossed structure so that, in the stack of the plurality of electrical steel sheets, interlocking portions of adjacent electrical steel sheets of the plurality of electrical steel sheets interlock.

3. The vacuum cleaner of claim 2, wherein
the interlocking portion includes:
a protrusion from a first surface, and
a recess from a second surface opposite the first surface, and
wherein the protrusion protrudes into the recess of an adjacent electrical steel sheet of the plurality of electrical steel sheets in the stack of the plurality of electrical steel sheets.

4. The vacuum cleaner of claim 2, wherein the interlocking portion is on at least one yoke shape or at least one tooth shape.

5. The vacuum cleaner of claim 2, wherein for each electrical steel sheet of the plurality of electrical steel sheets, a number of interlocking portions is less than a sum of a number of the yoke shapes and a number of the teeth shapes.

6. The vacuum cleaner of claim 2, wherein the interlocking portion includes two or more interlocking portions.

7. The vacuum cleaner of claim 1, wherein
the stator core further includes:
a bending portion that connects adjacent yokes of the plurality of yokes, and
the bending portion is bent toward a center of the stator core so that the stator core has an annular shape.

8. The vacuum cleaner of claim 1, wherein the adhesive layer includes a thermosetting adhesive.

9. The vacuum cleaner of claim 1, wherein
each yoke of the plurality of yokes has a width of 1 mm to 3 mm, and
each tooth of the plurality of teeth has a width of 0.5 mm to 3 mm.

10. The vacuum cleaner of claim 1, wherein
the stator core has an annular shape, and
each yoke of the plurality of yokes has an outer diameter of 20 mm to 40 mm.

11. The vacuum cleaner of claim 1, wherein
the stator core has an annular shape, and
each tooth of the plurality of teeth has an inner diameter of 5 mm to 20 mm.

12. A stator comprising:
a stator core including:
a plurality of yokes circumferentially around a center of the stator core;
a plurality of teeth respectively corresponding to the plurality of yokes, each tooth of the plurality of teeth extending from a respectively corresponding yoke of the plurality of yokes toward the center, and
a plurality of electrical steel sheets, each electrical steel sheet of the plurality of electrical steel sheets having yoke shapes respectively corresponding to the plurality of yokes and teeth shapes respectively corresponding to the plurality of teeth, and
wherein the plurality of electrical steel sheets are stacked with an adhesive layer between each two adjacent electrical steel sheets of the plurality of electrical steel sheets to form the stator core.

13. The stator of claim 12, wherein each electrical steel sheet of the plurality of electrical steel sheets includes an interlocking portion having an embossed structure so that, in the stack of the plurality of electrical steel sheets, interlocking portions of adjacent electrical steel sheets of the plurality of electrical steel sheets interlock.

14. The stator of claim 13, wherein
the interlocking portion includes:
a protrusion from a first surface, and
a recess from a second surface opposite the first surface, and
wherein the protrusion protrudes into the recess of an adjacent electrical steel sheet of the plurality of electrical steel sheets.

15. The stator of claim 13, wherein the interlocking portion is on at least one yoke shape or at least one tooth shape.

16. The stator of claim 13, wherein for each electrical steel sheet of the plurality of electrical steel sheets a number of interlocking portions is less than a sum of a number of the yoke shapes and a number of the teeth shapes.

17. The stator of claim 12, wherein
the stator core further includes:
a bending portion that connects adjacent yokes of the plurality of yokes, and
the bending portion is bent toward the center of the stator core so that the stator core has an annular shape.

18. A method for manufacturing a stator including a plurality of yokes, adjacent yokes of the plurality of yokes connected to each other through a bending portion, a plurality of teeth respectively corresponding to the plurality of yokes, each tooth of the plurality of teeth extending from a respectively corresponding yoke of the plurality of yokes, and a plurality of electrical steel sheets, each electrical steel sheet of the plurality of electrical steel sheets having yoke shapes respectively corresponding to the plurality of yokes and teeth shapes respectively corresponding to the plurality of teeth, the method comprising:
cutting a plurality of electrical steel sheets to form the yoke shapes and the teeth shapes in each electrical steel sheet of the plurality of electrical steel sheets;
applying an adhesive layer to a surface of at least one electrical steel sheet of the plurality of electrical steel sheets that are cut;
stacking the plurality of electrical steel sheets that are cut so that the adhesive layer is between each two adjacent electrical steel sheets of the plurality of electrical steel sheets to form a provisionally assembled stator;
heating the provisionally assembled stator to cure the applied adhesive layer;
forming an insulator by injecting an insulating material onto at least a portion of each tooth of the plurality of teeth of the provisionally assembled stator;
winding a stator coil around the insulator; and
bending the bending portion to form the stator into an annular shape.

19. The method of claim 18, further comprising embossing an interlocking portion into each electrical steel sheet of the plurality of electrical steel sheets so that interlocking portions of adjacent electrical steel sheets of the plurality of electrical steel sheets interlock when stacked.

20. The method of claim 18, wherein the heating is performed simultaneously with the stacking or after the stacking is completed.
